(19) United States
(12) Patent Application Publication
(10) Pub. No.: US 2018/0133998 A1
(43) Pub. Date: May 17, 2018

(54) DEVICE AND METHOD FOR PRODUCING FOLDING BOXES

(71) Applicant: MAYR-MELNHOF KARTON AG, Wien (AT)

(72) Inventors: Uwe THEIS, Riveris (DE); Jurgen KOLLMANN, Polich (DE)

(21) Appl. No.: 15/566,053

(22) PCT Filed: Apr. 14, 2016
(86) PCT No.: PCT/EP2016/058227

§ 371 Date: Oct. 12, 2017

(30) Foreign Application Priority Data
Apr. 14, 2015 (EP) 15163514.1

(51) Int. Cl. B31B 50/10; B31B 50/16; B31B 50/26; B31B 50/62; B23K 26/00; B23K 26/38

(52) U.S. Cl. CPC B31B 50/102; B31B 50/16; B31B 50/26; B31B 2100/002; B23K 26/0006; B23K 26/38; B31B 50/624

(57) ABSTRACT

The invention relates to a device (10) for producing folding boxes. The device (10) has a processing module (12) for producing at least one blank (16) from a web-shaped packaging material (18), wherein the processing module (12) has a packaging-material-web holding apparatus (20) for supporting the web-shaped packaging material, a packaging-material-web transporting apparatus (22) for transporting the web-shaped packaging material (18), and at least one working apparatus (24), by means of which the at least one blank (16) can be produced from the web-shaped packaging material (18), wherein the working apparatus (24) comprises at least one laser apparatus (26) for ablating packaging material substance. Furthermore, the device (10) has a folding module (14) for folding the at least one blank (16) into a folding box. The invention further relates to a method for producing a folding box.

The invention relates to a device and a method for producing folding boxes from a packaging material.

In producing folding boxes as a primary or secondary packaging, materials like cardboard, chipboard or solid board are usually used as a packaging material. According to type and purpose of employment of the folding box, these packaging material substances can additionally be coated, laminated or printed. For folding box production, the packaging materials are usually first sheet-shaped cut, placed in a punching station as a stack with the aid of a feeder and processed with flatbed punches or cutting platens in isolated manner to produce blanks with desired bending locations. Generally, it is the aim of the processing to produce the required contour and the desired bending locations of the blank. Subsequently, the blanks are transported to a folding station and there folded to the folding box according to the bending locations.

The circumstance is to be regarded as disadvantageous in the known devices and methods that the production of folding boxes is comparatively expensive and includes many individual steps partially to be manually performed.

It is the object of the present invention to provide a device and a method, which allow faster and more flexible production of folding boxes.

According to the invention, the objects are solved by a device having the features of claim 1 as well as by a method according to claim 11. Advantageous configurations with convenient developments of the invention are specified in the respective dependent claims, wherein advantageous configurations of the device are to be regarded as advantageous configurations of the method and vice versa.

A first aspect of the invention relates to a device for producing folding boxes. Therein, according to the invention, a faster and more flexible production of folding boxes is allowed in that the device comprises a processing module for producing at least one blank from a web-shaped packaging material, wherein the processing module includes a packaging-material-web holding apparatus for supporting the web-shaped packaging material, a packaging-material-web transporting apparatus for transporting the web-shaped packaging material and at least one working apparatus, by means of which the at least one blank can be produced from the web-shaped packaging material, wherein the working apparatus includes at least one laser apparatus for ablating packaging material substance. Furthermore, the device according to the invention comprises a folding module for folding the at least one blank to a folding box. In other words, in contrast to the prior art, it is provided according to the invention that a web-shaped packaging material can be inserted into the packaging-material-web holding apparatus of the processing module, from where it can be transported by means of a packaging-material-web transporting apparatus and be cut to the blank with the aid of a working apparatus of the processing module and be provided with bending locations. Hereto, the working apparatus includes at least one laser apparatus, by means of which material ablation is effected for specifically weakening the packaging material substance. Therein, the laser apparatus can basically be used for grooving, scribing, cutting and/or perforating the web-shaped packaging material as an ablating cutting apparatus. Unlike mechanical separating tools, the laser apparatus therein allows increased flexibility as well as the possibility of forming geometrically complex bending and cutting lines without complicated and expensive tool change. Therein, it can basically be provided that the laser apparatus includes multiple laser sources, for example laser diodes. Similarly, multiple identically or differently formed laser apparatuses can be provided for example to form a so-called laser array. In addition, with the aid of the processing module, the processing steps required heretofore of punching sheets from the web-shaped packaging material, stacking these sheets, further transporting these sheets to a punching station and isolated supply of the sheets to the punching station to produce blanks can be advantageously omitted. Accordingly, the device according to the invention can be formed without the corresponding stations and apparatuses, whereby corresponding cost decreases and installation space savings are realized. Subsequently, the blank can be further transported to the folding module downstream with respect to a transport direction of the packaging material and there be folded to the folding box. Thereby, the device according to the invention allows particularly fast, flexible and simple production of folding boxes directly from a web-shaped packaging material. By the modular construction of the device, different processing modules, in which the production of blanks from the web-shaped packaging material is effected, can additionally be particularly simply combined with different folding modules, in which the blanks are folded to folding boxes. This allows particularly fast and simple adaptation of the device to different packaging materials and folding box types. Furthermore, it can be provided that the folding module is formed for producing one- and/or multi-part folding boxes.

Depending on the packaging material and the working to be performed, it has proven advantageous if the laser apparatus includes at least one UV laser and/or at least one IR laser, in particular a CO₂ laser, and/or at least one laser operable in pulsed manner and/or at least one laser having a power of at least 1 W. Hereby, particularly fast and reliable working of the web-shaped packaging material is allowed. UV lasers and IR lasers generate radiation in different wavelength ranges, whereby optimum working results for different packaging materials can be ensured. By the laser being operable in pulsed manner, thus for example in the nano-, pico-, femto- or attosecond range, high peak intensities with very short duration can be generated, whereby a particularly precise material removal of the packaging material is allowed. According to used packaging material, it has proven advantageous if the power of the laser is above 1 W and is for example chosen in the range from 5 Watts to 200 Watts.

In a further advantageous configuration of the invention, it is provided that the laser apparatus is movable relative to a transport direction of the web-shaped packaging material and/or that the laser apparatus includes a controllable and/or adjustable optical system for deflecting and/or focusing its laser beam. This allows particularly high working and thereby transport speeds as well as the formation of particularly complex cutting and bending lines.

In a further advantageous configuration of the invention, it is provided that the working apparatus includes at least one mechanical tool in addition to the laser apparatus, by means of which the web-shaped packaging material is to be grooved, and/or scribed and/or cut and/or perforated and/or punched and/or embossed and/or broken out. Hereby, the working speed of the packaging material can be advantageously further increased. Moreover, working steps from the group of deforming, in particular pressure deforming, can also be performed with the aid of the mechanical tool besides separating steps, which could not be performed or only performed with great effort by the laser apparatus. For example, the mechanical tool can be formed as a rotary punch, band steel cutting tool, cutting knife, grooving knife, embossing tool or the like. Similarly, the mechanical tool can serve for separating the blank or blanks from the excess packaging material.

In a further advantageous configuration of the invention, it is provided that the processing module includes synchronizing means for synchronizing the packaging-material-web transporting apparatus and the working apparatus. In this manner, it is particularly reliably ensured that the working of the packaging material can be performed depending on its position and relative speed with respect to the working apparatus, whereby particularly high quality of the blanks formed from the packaging material is ensured. In particular, the production of the blank or blanks can be effected with “register accuracy”.

In a further advantageous configuration of the invention, it is provided that an inserting module is disposed between the processing module and the folding module, which is formed to collect multiple blanks from the processing module and/or to supply them to the folding module in isolated manner. This is in particular advantageous with severely different processing speeds of processing module and folding module and in other cases, in which continuous forwarding of the blanks produced in the processing module to the folding module is not possible or desirable.

Further advantages arise if the folding module includes an applying apparatus for applying adhesive to a flap area of the at least one blank. Hereby, the blanks can be folded and adhered. Therein, all of the suitable adhesives can basically be provided, wherein glue or a dispersion adhesive based on polyvinyl acetate lends itself in most cases.

In a further advantageous configuration of the invention, at least the packaging-material-web holding apparatus, the packaging-material-web transporting apparatus and the working apparatus are accommodated in a common housing. In this manner, the device is particularly compactly formed. Basically, it can also be provided that the folding module is also disposed in the common housing.

Further advantages arise in that the packaging-material-web holding apparatus is formed for retaining a reel of the web-shaped packaging material. This allows immediately inserting the web-shaped packaging material rolled up to a reel into the processing module or into the packaging-material-web holding apparatus thereof without further working steps, whereupon the packing material can be unrolled from the reel and further transported to further processing with the aid of the packaging-material-web transporting apparatus. Therein, a reel of the web-shaped packaging material is also referred to as a parent roll or bobbin. Further, it can be provided that the packaging-material-web holding apparatus comprises a roll magazine for two or more reels or parent rolls and/or a roll changing apparatus such that unrolled reels/empty rolls can preferably be removed from the processing module and can be replaced with a new reel or a new parent roll in automated manner.

In a further advantageous configuration of the invention, a suction apparatus is provided, by means of which excess packaging material can be removed from the at least one blank. In other words, it is provided to suck off excess packaging material, that is edges outside of the panel or blank contour, from the remaining blank during or after producing the blank. This represents a particularly simple and fast possibility of isolating the blanks as well as of removing excess packaging material. Basically, the suction apparatus can be a component of the processing module or the folding module or be arranged downstream of the working apparatus as a separate module.

A second aspect of the invention relates to a method for producing a folding box. Therein, according to the invention, the method includes at least the steps of supporting a web-shaped packaging material in a packaging-material-web holding apparatus of a processing module, transporting the web-shaped packaging material along a transport direction by means of a packaging-material-web transporting apparatus of the processing module, producing at least one blank from the web-shaped packaging material by means of a working apparatus of the processing module, wherein producing includes at least ablation of packaging material substance by means of at least one laser apparatus of the working apparatus, and folding the at least one blank to a folding box by means of a folding module. Thereby, the method according to the invention allows faster and more flexible production of folding boxes, for example of cigarette boxes. Further features and the advantages thereof are apparent from the descriptions of the first inventive aspect, wherein advantageous configurations of the first inventive aspect are to be regarded as advantageous configurations of the second inventive aspect and vice versa.

In an advantageous configuration of the invention, it is provided that the web-shaped packaging material is disposed as a reel in the packaging-material-web holding apparatus. This allows immediately inserting the web-shaped packaging material rolled up to a reel into the processing module or into the packaging-material-web holding apparatus thereof without further working steps, whereupon the packaging material is unrolled from the reel and further transported to further processing with the aid of the packaging-material-web transporting apparatus.

In a further advantageous configuration of the invention, the web-shaped packaging material is printed before arrangement in the packaging-material-web holding apparatus. Hereby, the subsequent folding box can be provided with information, certain surface properties, graphic elements etc. Although the packaging material is basically printable with all of the suitable printing methods, offset, gravure and flexographic printing methods have proven particularly advantageous and economic for most of the applications.

Further features of the invention are apparent from the claims and the embodiments. The features and feature combinations mentioned above in the description as well as the features and feature combinations mentioned below in the embodiments and/or shown alone are usable not only in the respectively specified combination, but also in other combinations or alone without departing from the scope of the invention. Thus, implementations are also to be considered as encompassed and disclosed by the invention, which are not explicitly shown and explained in the embodiments, but arise from and can be generated by separated feature combinations from the explained implementations. Implementations and feature combinations are also to be considered as disclosed, which thus do not have all of the features of an originally formulated independent claim. There shows:

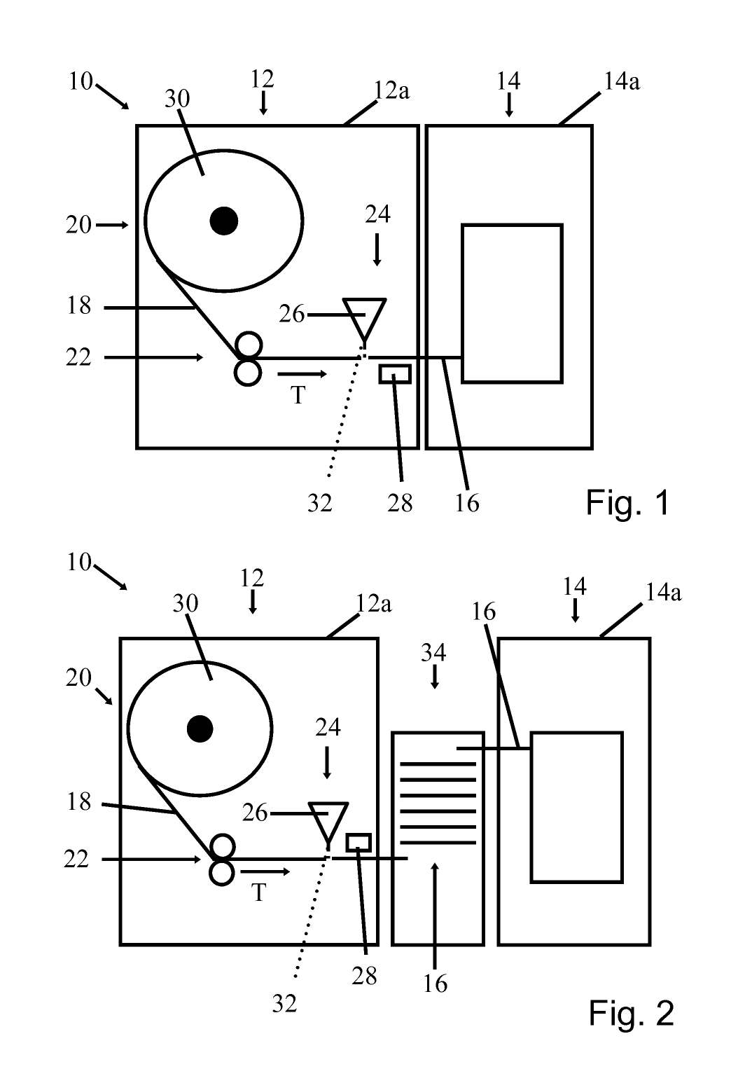

FIG. 1 a schematic representation of a device according to the invention for producing folding boxes according to a first embodiment; and

FIG. 2 a schematic representation of a device according to the invention for producing folding boxes according to a second embodiment.

FIG. 1 shows a schematic representation of a device 10 according to the invention for producing folding boxes according to a first embodiment. The device 10 is modularly constructed and includes a processing module 12 and a folding module 14. The processing module 12 serves for producing one or more blanks 16 from a web-shaped packaging material 18 and includes a packaging-material-web holding apparatus 20 for holding and supporting the web-shaped packaging material 18 in the processing module 12, a packaging-material-web transporting apparatus 22 for transporting the web-shaped packaging material 18 and at least one working apparatus 24, by means of which the at least one blank 16 can be produced from the web-shaped packaging material 18. For this purpose, the working apparatus 24 includes at least one laser apparatus 26 for ablating packaging material substance from the packaging material 18. In the shown embodiment, the working apparatus 24 additionally includes a basically optional mechanic tool 28, which is presently formed as a rotary punch. The folding module 14 is disposed downstream of the working apparatus 24 with respect to a transport direction T of the packaging material 18 and folds the blanks 16 produced from the packaging material 18 to corresponding folding boxes. The folding boxes are for example cigarette boxes.

The processing module 12 and the folding module 14 are accommodated in respective housings 12a, 14a, wherein a common housing can basically also be provided.

As one recognizes in FIG. 1, the web-shaped packaging material 18 is inserted into the packaging-material-web holding apparatus 20 as a reel 30 (parent roll) and processed to corresponding blanks 16 without further intermediate steps such as for example sheet punching or the like. Therein, the packaging material 18 can be printed or unprinted and is composed of cardboard with a grammage of about 150 g/m² in the present embodiment, wherein other materials such as chipboard or solid board and paper sorts, respectively, with grammages between 40 g/m² and 1000 g/m², in particular between 120 g/m² and 250 g/m², can basically also be provided.

With the aid of the working apparatus 24, the web-shaped packaging material 18 unwound from the reel 30 is grooved and/or scribed and/or cut and/or perforated and/or punched and/or embossed and/or broken out as needed. It is the aim to generate the required contour of the blank 16 and to produce bending locations, which set the location of bending, allow hinge-like movement of the bending location and weaken the rigidity of the packaging material 18 at this location such that undisturbed folding to the folding box is ensured in the folding module 14. In the shown embodiment, the laser apparatus 26 includes a CO₂ laser operable in pulsed manner in the picosecond range with a power of 50 W and predominantly serves for cutting, grooving and perforating the packaging material 18. The mechanical tool 28 supports the laser apparatus 26 in producing the contours of the blanks 16. The laser apparatus 26 is movable relative to the transport direction of the web-shaped packaging material 18. In addition, the laser beam 32 can be deflected and focused via an adjustable optical system (not shown) such that particularly complex cutting and grooving lines can be generated in the packaging material 18. Correspondingly complex and optionally multi-part folding boxes can be subsequently produced from these blanks 16 with the aid of the folding module 14.

FIG. 2 shows a schematic representation of a device 10 according to the invention for producing folding boxes according to a second embodiment. The basic construction of the device 10 is already known from the preceding description of the first embodiment. In contrast to the first embodiment, the device 10 shown in FIG. 2 includes a mechanical tool 28 formed as an embossing tool, by means of which Braille can for example be produced in the packaging material 18. Similarly, it can be provided that the mechanical tool 28 is used for pressing the blanks 16 out of the remaining packaging material 18, whereby the blanks 16 can be isolated at the same time. A further difference to the first embodiment is in that an inserting module 34 is disposed between the processing module 12 and the folding module 14, which is formed to collect multiple blanks 16 from the processing module 12 and to supply them to the folding module 14 in isolated manner. This is advantageous in cases, in which continuous forwarding of the blanks 16 produced in the processing module 12 to the folding module 14 is not possible or desirable. Alternatively or additionally, it can be provided that a suction apparatus (not shown) is disposed downstream of the working apparatus 24, by means of which excess packaging material 18 is sucked from the produced blanks 16. Alternatively or additionally to the suction apparatus, a depaneling apparatus known per se can basically also be provided.

The parameter values indicated in the documents for the definition of process and measurement conditions for the characterization of specific characteristics of the inventive subject matter are to be considered as encompassed by the scope of the invention also within the scope of deviations—for example due to measurement errors, system errors, weighing errors, DIN tolerances and the like.

1. A device for producing folding boxes comprising:
a processing module for producing at least one blank from a web-shaped packaging material, wherein the processing module comprises
a packaging-material-web holding apparatus for supporting the web-shaped packaging material,
a packaging-material-web transporting apparatus for transporting the web-shaped packaging material, and
at least one working apparatus, by means of which the at least one blank can be produced from the web-shaped packaging material, wherein the working apparatus includes at least one laser apparatus for ablating packaging material substance; and
a folding module for folding the at least one blank to a folding box.

2. The device according to claim 1, wherein the laser apparatus includes at least one of a UV laser, an IR laser, a laser operable in pulsed manner, and/or a laser having a power of at least 1 W.

3. The device according to claim 1, wherein the laser apparatus is movable relative to a transport direction of the web-shaped packaging material (18).

4. The device according to claim 1, wherein the working apparatus includes at least one mechanical tool in addition to the laser apparatus, by means of which the web-shaped packaging material is to be at least one of grooved, scribed, cut, perforated, punched, embossed, and/or broken out.

5. The device according to claim 1, wherein the processing module includes synchronizing means for synchronizing the packaging-material-web transporting apparatus and the working apparatus.

6. The device according to claim 1, wherein an inserting module is disposed between the processing module and the folding module, which is formed to collect multiple blanks from the processing module and/or to supply them to the folding module in isolated manner.

7. The device according to claim 1, wherein the folding module includes an applying apparatus for applying adhesive to a flap area of the at least one blank.

8. The device according to claim 1, wherein at least the packaging-material-web holding apparatus, the packaging-material-web transporting apparatus and the working apparatus are accommodated in a common housing.

9. The device according to claim 1, wherein the packaging-material-web holding apparatus is formed for retaining a reel of the web-shaped packaging material.

10. The device according to claim 1, wherein a suction apparatus is provided, by means of which excess packaging material can be removed from the at least one blank.

11. A method for producing a folding box, comprising:
supporting a web-shaped packaging material in a packaging-material-web holding apparatus of a processing module;
transporting the web-shaped packaging material along a transport direction by means of a packaging-material-web transporting apparatus of the processing module;
producing at least one blank from the web-shaped packaging material by means of a working apparatus of the processing module, wherein the production includes at least ablation of packaging material substance by means of at least one laser apparatus of the working apparatus; and
folding the at least one blank to a folding box by means of a folding module.

12. The method according to claim 11, wherein the web-shaped packaging material is disposed as a reel in the packaging-material-web holding apparatus.

13. The method according to claim 11, wherein the web-shaped packaging material is printed before disposing in the packaging-material-web holding apparatus.

14. The method according to claim 12, wherein the web-shaped packaging material is printed before disposing in the packaging-material-web holding apparatus.

15. The device according to claim 1, wherein the laser apparatus includes a controllable and/or adjustable optical system for deflecting and/or focusing its laser beam.

16. The device according to claim 1, wherein the laser apparatus includes a CO2 laser.
